(19) United States
(12) Patent Application Publication
(10) Pub. No.: US 2014/0323930 A1
(43) Pub. Date: Oct. 30, 2014

(54) TREATMENT OF LYMPHEDEMA USING PROTEOLYTIC AGENTS

(71) Applicant: Advanced Healthcare Consulting, LLC, Franklin, TN (US)

(72) Inventor: Doran Devon Edwards, Franklin, TN (US)

(73) Assignee: Advanced Healthcare Consulting, LLC, Franklin, TN (US)

(21) Appl. No.: 14/264,940

(22) Filed: Apr. 29, 2014

Related U.S. Application Data
(60) Provisional application No. 61/816,904, filed on Apr. 29, 2013.

(51) Int. Cl. A61H 23/00; A61H 9/00

(52) U.S. Cl. CPC A61H 23/00; A61H 9/00
USPC 601/46; 424/94.1; 424/94.62; 424/94.64; 424/94.63

(57) ABSTRACT

The technology relates to the use of a proteolytic enzyme, for example hyaluronidase, for the treatment of abnormal protein collection in a patient's lymphatic system. In addition, the present technology provides a composition and a combined preparation each comprising hyaluronidase and at least one further proteolytic enzyme, and a method of prevention and/or treating primary or secondary edema in a patient in need thereof, wherein the patient is administered a therapeutically effective amount of hyaluronidase.

### CROSS REFERENCE

This application claims priority to U.S. Provisional Application No. 61/816,904 entitled “Treatment of Lymphedema Using Proteolytic Agents” filed on Apr. 29, 2013, which is hereby incorporated by reference in its entirety.

### BACKGROUND

Lymphedema results from a deficiency, blocking, or dysfunction of the lymphatic system that limits the flow of lymph fluid from a body area. The most frequent causes of lymphedema include primary insufficiency, traumatic accidents, chronic inflammatory and infectious processes, diabetic complications, chronic venous diseases, radiation therapy of the lymph nodes, prostate operations, mastectomies, amputations and other surgical operations. Lymphedema most typically occurs in arms and legs, but essentially any body areas can become lymphedemic, such as the genitals and the trunk of the body.

Lymphedema and edema can cause swelling of limbs, disfiguring skin disorders, reduction in mobility, pain, embarrassment and serious emotional depression. Rapid swelling, such as caused by radiation therapy or a surgical operation, can be especially painful as the body tissue is effectively being torn apart by the fluid pressure. The World Health Organization recently estimated that approximately 500 million people currently suffer from some form of lymphedema.

Individual cases of lymphedema are typically assigned to either a primary or a secondary class. Primary lymphedema is often a genetically determined condition, in which the lymphatic system is chronically or acutely overwhelmed by the volume of lymphatic fluid to be evacuated. Acute primary lymphedema, and edema, can be caused by an injury or trauma where the lymph system is properly functioning but is temporarily overwhelmed. Swelling and/or edema caused by burns, sprains and other injuries are typically alleviated after a few days or weeks in a patient in generally good health. However, even temporary swelling can be painful to the patient and can result in fibrosis.

Secondary lymphedema typically presents as a relatively sudden cessation or deep reduction of the functionality of a portion of the lymphatic system. The most frequently occurring causes of secondary lymphedema include chronic inflammation/infection associated with underlying medical conditions such as diabetes, radiation therapy, mastectomies, amputations and other surgical operations. Regardless of cause or class, a significant limitation or attenuation of the necessary progress of lymphatic fluid flow through the lymphatic system may result in a concentration or swelling of the protein bearing lymph fluid in the interstitial area of the soft tissue of an affected limb or body region. Incompletely or poorly treated chronic lymphedema more often results in severe and even life threatening consequences than acute edemas. Any sustained accumulation of fluid and/or proteins delivered to the body tissue by the blood capillaries, and not removed by the lymphatic system, will cause an accumulation of fluid in the interstitial areas of the body tissues and localized swelling of the area. The oxygenation of adjacent tissue is thereby reduced and the healing process is retarded. A localized accumulation of proteins further compounds this situation by directly stimulating chronic inflammation. Chronic inflammation impairs normal lymphatic flow and usually results in the formation and dilation of additional capillaries. These additional blood vessels deliver additional fluid and undesirable excess heat to the swollen area. This inopportune heating of the protein rich interstitial fluid increases the incidence and virulence of opportunistic bacteriological infections.

Conventional treatment techniques for lymphedema include the use of anti-inflammatory, diuretic and antibacterial drugs, massage therapy, physical exercise, compression bandages and compression garments. Treatment strategies that apply physical pressure to a swollen, edemic or lymphedemic body area can be divided into those which provide intermittent forced compression and those which maintain a relatively constant pressure over time.

### SUMMARY

Embodiments of the present invention relate to the use of a proteolytic enzyme for the prevention and/or treatment of abnormal protein collection in a patient's lymphatic system (i.e. lymphedema). In addition, embodiments provide a composition or compositions, each comprising hyaluronidase and at least one further proteolytic enzyme, and a method of prevention and/or treating primary or secondary lymphedema in a patient in need thereof, wherein the patient is to be administered a therapeutically effective amount of proteolytic enzyme wherein the lymphedema is treated.

### DETAILED DESCRIPTION

Embodiments of the invention are directed to administration of proteolytic enzymes that can effectively hydrolyze proteins that have abnormally collected in a subject's lymphatic system, allowing for the use of pressure to remove the smaller protein fragments and fluid, resulting in reduction of patients suffering from primary or secondary edema. Apart from rare allergic reactions against hyaluronidase, only bacterial infections are known as a contraindication for a hyaluronidase-based treatment. Thus, hyaluronidase-based treatment avoids a large number of side effects and limitations associated with the anti-edema treatments known in the art. Embodiments further include applying pressure to the affected area.

In some embodiments, the proteolytic enzyme is a hyaluronidase enzyme. In other embodiments, the proteolytic enzyme comprises tissue plasminogen activator (t-PA), anistreplase, urokinase, streptokinase, or combinations thereof. The treatment may comprise administration of a hyaluronidase enzyme and a second protease enzyme. In embodiments, the hyaluronidase may come from Staphylococcus aureus, Streptococcus pyogenes, or Clostridium perfringens. In some embodiments, the hyaluronidase is synthetic (recombinant or rDNA) human hyaluronidase. In still other embodiments, the treatment comprises administration of two or more protease enzymes. In certain embodiments, the treatment comprises administration of two hyaluronidase enzymes. In some embodiments, one or more proteolytic enzymes may be administered into the lymphatic system, into deep tissue, at the site of edimic or lymphedemic body area, or any combination thereof.

The method of any embodiment may comprise a waiting period between applying the proteolytic enzyme and applying pressure. In some embodiments, the waiting period is about ten minutes to about twenty-four hours. In various embodiments, the waiting period may be at least about ten minutes, at least about 30 minutes, at least about one hour, at least about two hours, at least about 4 hours, at least about 6 hours, at least about 8 hours, at least about 12 hours, at least about 24 hours, or at least a time period between any two of these time periods.

The protease enzyme or enzymes are delivered to a portion of the body in need of treatment. The enzymes may be applied topically, wherein the protease enzymes adsorb through the dermis into the underlying deeper tissues. For topical, external application, the enzymes may be formulated in a lotion, gel, patch, or combinations thereof. The hyaluronidase makes the dermis more permeable to the passage of molecules, including in some embodiments, the passage of a second proteolytic enzyme. In other embodiments, the protease enzyme may be injected subcutaneously to the site of the abnormal protein collection, or into nearby tissues that would allow flow through interstitial fluids to the site of the abnormal protein collection causing lymphedema. If a plurality of protease enzymes are used, they may be applied in a single formulation, at least two separate formulations, or at least two different modes of application.

Embodiments of the methods apply pressure through compression means appropriate for the area of the body affected. The means include, but are not limited to a massage, a sonic massage device, a vibrational massage device, a wrap, stockings, a pneumatic compression sleeve, or combinations thereof. Devices may be used to apply pressure to limbs-legs, arms and/or feet. Elastic and non-elastic stockings may be employed in support and compression therapy of the foot and ankle. Other devices may use pulsating pads for improving circulation. Others may use hydraulic and pneumatic bladders for the same or other purposes. The shapes, sizes and composition of such bladders and pads vary widely, depending largely on the particular application. Therapeutic devices may be capable of applying therapeutic compression to the body, particularly the limbs, arms and/or feet, in which the user applies non-elastic therapeutic compression band by band, and the user can tighten the compression bands to control the non-elastic pressure. Cyclical or sequential compression of limbs improves blood fluid returns for reducing edema and improving healing.

The methods may feature treating a subject with abnormal protein collection, e.g., a subject in need of increased lymphatic flow, e.g., a subject identified as having, or at risk for, lymphedema, e.g., primary or secondary lymphedema. The subject may be a human, e.g., a human diagnosed with primary or secondary lymphedema. In some embodiments, the abnormal protein collection comprises protein-containing fluid, a mild brawny edema, moderately brawny edema, or other forms of lymphedematous fluid. In other embodiments, the abnormal protein collection comprises cross-linked protein, fibrin, collagen, mucus, lymphatic fluid, blood degradation products, and combinations thereof. Embodiments may also be used to treat cystic fibrosis, acute inflammation, chronic inflammation, autoimmune disorder, chronic recurrent cysts, fibro-adenoma of the breast, scars, keloids, and combinations thereof. In other embodiments, the abnormal protein collection comprises cross-linked protein, fibrin, collagen, mucus, lymphatic fluid, blood degradation products, and combinations thereof.

Compositions comprise a therapeutically effective amount of a lymphedema treating agent applied to a subject having abnormal protein collection in the subject's lymphatic system. The compositions comprise at least one proteolytic enzyme as the treating agent in a pharmaceutically acceptable carrier for deep tissue delivery of the proteolytic enzyme. In some embodiments, the proteolytic enzyme comprises a hyaluronidase enzyme. In various embodiments, the composition comprises a plurality of proteolytic enzymes. The proteolytic enzymes may comprise at least one of t-PA, anistreplase, urokinase, streptokinase, or combinations thereof. Any of the above embodiments may comprise a topical application. The topical application may comprise a gel, lotion, cream, ointment or similar formulation. Various embodiments of compositions further comprises an excipient, carrier diluent, or auxiliary agent. The composition may deliver at least one proteolytic agent to lymphatic channels, interstitial fluids of the lymphatic system, and extracellular areas of the lymphatic system. Further, the composition may comprise a time-release agent.

The term “epidermis” refers hereinafter in a non-limiting manner to the outermost layer of the skin. The term “dermis” refers hereinafter in a non-limiting manner to layers of skin beneath the epidermis that consists of cells and connective tissue, and cushions the body from stress and strain. The term “deep tissue” refers hereinafter in a non-limiting manner to tissues beneath the dermis. Deep tissue may include, but is not limited to lymphatic channels, interstitial fluids of the lymphatic system, and extracellular areas of the lymphatic system.

In various embodiments, a pharmaceutical composition is provided which comprises hyaluronidase, a composition comprising hyaluronidase and at least one further proteolytic enzyme separately applied, or the combined preparation comprising hyaluronidase and at least one further proteolytic enzyme. In an embodiment, the pharmaceutical composition comprises a therapeutically effective amount of hyaluronidase as a mixture with at least one pharmaceutically and/or physiologically acceptable formulation agent, at least one vehicle and/or at least one carrier, the formulation agent, the vehicle and the carrier selected for suitability with the mode of administration. In another embodiment, the pharmaceutical composition comprises a therapeutically effective amount of hyaluronidase and a therapeutically effective amount of at least one further proteolytic enzyme, as a mixture with at least one pharmaceutically and/or physiologically acceptable formulation agent, at least one vehicle and/or at least one carrier, the formulation agent, the vehicle and the carrier selected for suitability with the mode of administration.

Such acceptable formulation agents are generally known in the art and interalia comprise agents for modifying, maintaining, or preserving, for example, the pH, osmolarity, viscosity, clarity, color, isotonicity, odor, sterility, stability, rate of dissolution or release, adsorption, or penetration of the composition. Suitable formulation agents include, but are not limited to, amino acids (such as glycine, glutamine, asparagine, arginine, or lysine), antimicrobials, antioxidants (such as ascorbic acid, sodium sulfite, or sodium hydrogen-sulfite), buffers (such as borate, bicarbonate, Tris-HCl, citrates, phosphates, or other organic acids), bulking agents (such as mannitol or glycine), chelating agents (such as ethylenediamine tetraacetic acid (EDTA)), complexing agents (such as caffeine, polyvinylpyrrolidone, beta-cyclodextrin, or hydroxypropyl-beta-cyclodextrin), fillers, monosaccharides, disaccharides, and other carbohydrates (such as glucose, mannose, or dextrins), proteins (such as serum albumin, gelatin, or immunoglobulins), coloring, flavoring and diluting agents, emulsifying agents, hydrophilic polymers (such as polyvinylpyrrolidone), low molecular weight polypeptides, salt-forming counterions (such as sodium), preservatives (such as benzalkonium chloride, benzoic acid, salicylic acid, thimerosal, phenethyl alcohol, methylparaben, propylparaben, chlorhexidine, sorbic acid, or hydrogen peroxide), solvents (such as glycerin, propylene glycol, or polyethylene glycol), sugar alcohols (such as mannitol or sorbitol), suspending agents, surfactants or wetting agents (such as Pluronics®, PEG, sorbitan esters, polysorbates such as polysorbate 20 or polysorbate 80, Triton®, tromethamine, lecithin, cholesterol, or tyloxapal), stability enhancing agents (such as sucrose or sorbitol), tonicity enhancing agents (such as an alkali metal halides, for example, sodium chloride or potassium chloride-or mannitol sorbitol), delivery vehicles, diluents, excipients and/or pharmaceutical adjuvants. See Remington's Pharmaceutical Sciences (18th Ed., A. R. Gennaro, ed., Mack Publishing Company 1990).

In one embodiment, the subject has primary lymphedema. In another embodiment, the subject has secondary lymphedema, or is at risk for secondary lymphedema, e.g., the patient has undergone or will undergo a procedure that results in removal of, or damage to, the lymphatic system, e.g., the patient has undergone or will undergo surgery, radiation, infection or trauma that affects the lymphatic system

In some embodiments, the agent is administered in combination with one or more adjunctive treatments for lymphedema, e.g., manual lymphatic drainage, bandaging, pumps, compression garments, antibiotics, or diuretics.

In an embodiment, the agent is administered via local administration to the affected tissue. For example, the agent is administered by topical application, transdermally, or subcutaneously in the area of the affected tissue.

In another embodiment, the agent is administered in a lipid-based formulation, e.g., a liposome or the agent is coupled to a lipophilic moiety. Such formulations can be administered, e.g., orally, e.g., to be taken up by the intestinal lymph, or topically.

In yet another embodiment, the proteolytic enzyme is coupled to a moiety, e.g., a macromolecule that is preferentially taken up by lymphatic vessels relative to vascular vessels. For example, in various specific embodiments, the agent can be coupled to a macromolecule that is between about 10 and about 200 nm, e.g., between about 10 and about 50 nm, between about 50 and about 100 nm, between about 100 and about 150 nm, between about 150 and about 200 nm, or between about 50 and about 150 nm. The moiety can be, e.g., dextran (e.g., dextran having a mass of at least about 100,000 Da; at least about 500,000 Da; at least about 1 million Da; at least about 2 million Da, or a mass of about 100,000 Da to about 2 million Da), or a monoclonal antibody targeted to lymphatic vessels.

In certain cases, it may possible to deliver the proteolytic enzyme directly, e.g., deliver to a site where increased proteolytic enzyme is required. The proteolytic enzyme can be produced exogenously from the subject.

In some embodiments, the method includes evaluating the subject for one or more of: lymph node status, joint flexibility, skin fullness and/or tightness, and blood clots. The evaluation can be performed before, during, and/or after the administration of the agent. For example, the evaluation can be performed at least about 1 day, at least about 2 days, at least about 4 days, at least about 7 days, at least about 14 days, at least about 21 days, at least about 30 days, or a range from between any two of these values before and/or after the administration.

In an embodiment, the administration of an agent can be initiated: when the subject begins to show signs of lymphedema; when lymphedema is diagnosed; at the time a treatment for lymphedema is begun or begins to exert its effects; before, during or following surgery, trauma or radiation therapy, or generally, as is needed to maintain health.

The period over which the agent is administered (or the period over which clinically effective levels are maintained in the subject) can be long term, e.g., for six months or more or a year or more or a lifetime. The period may be short term, e.g., for up to or less than a about a day, a about a week, about two weeks, at least about one month, at least about three months, or at least about six months. The terms “treat”, “treated”, or “treating” as used herein refer to both therapeutic treatment and preventative measures, wherein the object is to prevent or slow down an undesired physiological condition, disorder or disease, or to obtain beneficial or desired clinical results. For the purposes of this disclosure, beneficial or desired clinical results include, but are not limited to, alleviation of symptoms; diminishment of the extent of the condition, disorder or disease; stabilization of the state of the condition, disorder or disease; delay in onset or slowing of the progression of the condition, disorder or disease; amelioration of the condition, disorder or disease state; and remission (whether partial or total), whether detectable or undetectable, or enhancement or improvement of the condition, disorder or disease. Treatment includes eliciting a clinically significant response without excessive levels of side effects. Treatment also includes prolonging survival as compared to expected survival if not receiving treatment.

As used herein, a proteinaceous compound is one that includes at least three peptide bonds. Typically, a proteinaceous compound is polypeptide of greater than 20 amino acids. A non-proteinaceous compound is one that is not a proteinaceous compound.

This description also features the use of the protease enzymes to provide the respective treatments suited for the compounds and to provide medicaments for such respective treatments.

As it is used herein “proteolytic enzyme” or “protease” means carbonyl hydrolases which generally act to cleave peptide bonds of proteins or peptides. As used herein, “proteolytic enzyme” means a naturally occurring protease or recombinant protease. Naturally-occurring proteases include α-aminoacylpeptide hydrolase, peptidylamino acid hydrolase, acylamino hydrolase, serine carboxypeptidase, metallocarboxypeptidase, thiol proteinase, carboxylproteinase and metalloproteinase. Serine, metallo, thiol and acid protease are included, as well as endo and exo-proteases.

Proteolytic enzymes includes protease enzymes which are non-naturally occurring carbonyl hydrolase variants (protease variants) having a different proteolytic activity, stability, substrate specificity, pH profile and/or performance characteristic as compared to the precursor carbonyl hydrolase from which the amino acid sequence of the variant is derived. Specifically, such protease variants have an amino acid sequence not found in nature, which is derived by replacement of a plurality of amino acid residues of a precursor protease with different amino acids. The precursor protease may be a naturally-occurring protease or recombinant protease. The protease variants are designed to have trypsin-like specificity.

As it is used herein “hyaluronidase” is a compound belonging to the so-called beta (1-4)-glycosidases. Hyaluronidase hydrolyses hyaluronic acid (a linear heteroglycan with alternating glucuronic acid and N-acetyl-glucosamine residues), hyaluronate (the ionic form of hyaluronic acid), and chondroitin sulphate. The “hyaluronidase” can be derived from any source whatsoever. For example, the hyaluronidase may be derived from a mammal such as from human, mouse, rat, pig, sheep or cow. For instance, the hyaluronidase may be recovered from bovine protein (bovine type), alternatively from leeches or bacteria (e.g. in the form of hyaluronate lyase). The hyaluronidase can also be of vegetable origin. The hyaluronidase can be isolated, for instance, from potatoes, tobaccos and peas. Purification, chemical synthesis and genetic engineering techniques including production in a transgenic host generally known in the art can likewise be used to produce hyaluronidase. In certain embodiments, the hyaluronidase may come from Staphylococcus aureus, Streptococcus pyogenes, or Clostridium perfringens. In some embodiments, the hyaluronidase is synthetic (recombinant or rDNA) human hyaluronidase. In still other embodiments, the treatment comprises administration of two or more protease enzymes. In certain embodiments, the treatment comprises administration of two hyaluronidase enzymes.

Pharmaceutical compositions for use in treatment of lymphedema can be formulated by standard techniques using one or more physiologically acceptable carriers or excipients. In an embodiment, the formulations may contain a buffer and/or a preservative. The protease enzymes and their physiologically acceptable salts and solvates can be formulated for administration by any suitable route, including via inhalation, topically, dermally, nasally, orally, parenterally (e.g., intravenously, intraperitoneally, intravesically or intrathecally) or rectally in a vehicle comprising one or more pharmaceutically acceptable carriers, the proportion of which is determined by the solubility and chemical nature of the peptide, chosen route of administration and standard biological practice.

The terms “carrier”, “excipient”, “diluent”, and “adjuvant” may be used interchangeably and refer to a composition with which the therapeutic agent is administered. According to some embodiments, pharmaceutical compositions are provided comprising effective amounts of one or more compound(s) together with, for example, pharmaceutically acceptable diluents, preservatives, solubilizers, emulsifiers, adjuvants and/or other carriers. Such compositions include diluents of various buffer content (e.g., tris or other amines, carbonates, phosphates, amino acids, for example, glycinamide hydrochloride (especially in the physiological pH range), N-glycylglycine, sodium or potassium phosphate (dibasic, tribasic), etc. or Tris-HCl or acetate), pH and ionic strength; additives such as detergents and solubilizing agents (e.g., surfactants such as Pluronics®, Tween® 20, Tween® 80 (polysorbate 80), Cremophor®, polyols such as polyethylene glycol, propylene glycol, etc.), anti-oxidants (e.g., ascorbic acid, sodium metabisulfite), preservatives (e.g., thiomersol, benzyl alcohol, parabens, etc.) and bulking substances (e.g., sugars such as sucrose, lactose, mannitol, polymers such as polyvinylpyrrolidones or dextran, etc.); and/or incorporation of the material into particulate preparations of polymeric compounds such as polylactic acid, polyglycolic acid, etc. or into liposomes. Hyaluronic acid may also be used. Such compositions can be employed to influence the physical state, stability, rate of in vivo release, and rate of in vivo clearance of a compound. See, e.g., Remington's Pharmaceutical Sciences, 18th Ed. (1990, Mack Publishing Co., Easton, Pa. 18042) pages 1435-1712 which are herein incorporated by reference. The compositions can, for example, be prepared in liquid form, or can be in dried powder, such as lyophilized form. Particular methods of administering such compositions are described infra.

Where a buffer is to be included in the formulations, the buffer is selected from the group consisting of sodium acetate, sodium carbonate, citrate, glycylglycine, histidine, glycine, lysine, arginine, sodium dihydrogen phosphate, disodium hydrogen phosphate, sodium phosphate, and tris(hydroxymethyl)-aminomethane, or mixtures thereof. Each one of these specific buffers constitutes an alternative embodiment. In an embodiment, the buffer is glycylglycine, sodium dihydrogen phosphate, disodium hydrogen phosphate, sodium phosphate or mixtures thereof.

Where a pharmaceutically acceptable preservative is to be included in the formulations, the preservative is selected from the group consisting of phenol, m-cresol, methyl p-hydroxybenzoate, propyl p-hydroxybenzoate, 2-phenoxyethanol, butyl p-hydroxybenzoate, 2-phenylethanol, benzyl alcohol, chlorobutanol, and thiomerosal, or mixtures thereof. Each one of these specific preservatives constitutes an alternative embodiment.

In a further embodiment, the preservative is present in a concentration from about 0.1 mg/ml to about 50 mg/ml, in a concentration from about 0.1 mg/ml to about 25 mg/ml, or in a concentration from about 0.1 mg/ml to about 10 mg/ml.

The use of a preservative in pharmaceutical compositions is well-known to the skilled person. For convenience reference is made to Remington: The Science and Practice of Pharmacy, 19th edition, 1995.

In a further embodiment, the formulation may further comprise a chelating agent selected from salts of ethylene diamine tetraacetic acid (EDTA), citric acid, and aspartic acid, and mixtures thereof. Each one of these specific chelating agents constitutes an alternative embodiment.

In a further embodiment, the chelating agent is present in a concentration from about 0.1 mg/ml to about 5 mg/ml. In a further embodiment, the chelating agent is present in a concentration from about 0.1 mg/ml to about 2 mg/ml. In a further embodiment, the chelating agent is present in a concentration from about 2 mg/ml to about 5 mg/ml.

The use of a chelating agent in pharmaceutical compositions is well-known to the skilled person. For convenience reference is made to Remington: The Science and Practice of Pharmacy, 19th edition, 1995.

In a further embodiment, the formulation may further comprise a stabilizer selected from the group of high molecular weight polymers or low molecular compounds where such stabilizers include, but are not limited to, polyethylene glycol (e.g. PEG 3350), polyvinylalcohol (PVA), polyvinylpyrrolidone, carboxymethylcellulose, different salts (e.g. sodium chloride), L-glycine, L-histidine, imidazole, arginine, lysine, isoleucine, aspartic acid, tryptophan, threonine and mixtures thereof. Each one of these specific stabilizers constitutes an alternative embodiment. In an embodiment, the stabilizer is selected from the group consisting of L-histidine, imidazole and arginine.

In a further embodiment, the formulation may further comprise a surfactant where a surfactant may be selected from a detergent, ethoxylated castor oil, polyglycolyzed glycerides, acetylated monoglycerides, sorbitan fatty acid esters, poloxamers, such as 188 and 407, polyoxyethylene sorbitan fatty acid esters, polyoxyethylene derivatives such as alkylated and alkoxylated derivatives (Tweens®, e.g. Tween® 20, or Tween® 80), monoglycerides or ethoxylated derivatives thereof, diglycerides or polyoxyethylene derivatives thereof, glycerol, cholic acid or derivatives thereof, lecithins, alcohols and phospholipids, glycerophospholipids (lecithins, kephalins, phosphatidyl serine), glyceroglycolipids (galactopyransoide), sphingophospholipids (sphingomyelin), and sphingoglycolipids (ceramides, gangliosides), DSS (docusate sodium, docusate calcium, docusate potassium, SDS (sodium dodecyl sulfate or sodium lauryl sulfate), dipalmitoyl phosphatidic acid, sodium caprylate, bile acids and salts thereof and glycine or taurine conjugates, ursodeoxycholic acid, sodium cholate, sodium deoxycholate, sodium taurocholate, sodium glycocholate, N-Hexadecyl-N,N-dimethyl-3-ammonio-1-propanesulfonate, anionic (alkyl-aryl-sulphonates) monovalent surfactants, palmitoyl lysophosphatidyl-L-serine, lysophospholipids (e.g. 1-acyl-sn-glycero-3-phosphate esters of ethanolamine, choline, serine or threonine), alkyl, alkoxyl (alkyl ester), alkoxy (alkyl ether)-derivatives of lysophosphatidyl and phosphatidylcholines, e.g. lauroyl and myristoyl derivatives of lysophosphatidylcholine, dipalmitoylphosphatidylcholine, and modifications of the polar head group, that is cholines, ethanolamines, phosphatidic acid, serines, threonines, glycerol, inositol, and the positively charged DODAC, DOTMA, DCP, BISHOP, lysophosphatidylserine and lysophosphatidylthreonine, zwitterionic surfactants (e.g. N-alkyl-N,N-dimethylammonio-1-propanesulfonates, 3-cholamido-1-propyldimethylammonio-1-propanesulfonate, dodecylphosphocholine, myristoyl lysophosphatidylcholine, hen egg lysolecithin), cationic surfactants (quarternary ammonium bases) (e.g. cetyl-trimethylammonium bromide, cetylpyridinium chloride), non-ionic surfactants, polyethyleneoxide/polypropyleneoxide block copolymers (Pluronic®/Tetronic®, Triton® X-100, dodecyl β-D-glucopyranoside) or polymeric surfactants (Tween® 40, Tween® 80, Brij® 35), fusidic acid derivatives—(e.g. sodium tauro-dihydrofusidate etc.), long-chain fatty acids and salts thereof C6-C12 (e.g. oleic acid and caprylic acid), acylcarnitines and derivatives, Nα-acylated derivatives of lysine, arginine or histidine, or side-chain acylated derivatives of lysine or arginine, Nα-acylated derivatives of dipeptides comprising any combination of lysine, arginine or histidine and a neutral or acidic amino acid, Nα-acylated derivative of a tripeptide comprising any combination of a neutral amino acid and two charged amino acids, or the surfactant may be selected from the group of imidazoline derivatives, or mixtures thereof. Each one of these specific surfactants constitutes an alternative embodiment.

The use of a surfactant in pharmaceutical compositions is well-known to the skilled person. For convenience reference is made to Remington: The Science and Practice of Pharmacy, 19th edition, 1995.

The formulations may be prepared by conventional techniques, e.g. as described in Remington's Pharmaceutical Sciences, 1985 or in Remington: The Science and Practice of Pharmacy, 19th edition, 1995, where such conventional techniques of the pharmaceutical industry involve dissolving and mixing the ingredients as appropriate to give the desired end product.

The phrase “pharmaceutically acceptable” or “therapeutically acceptable” refers to molecular entities and compositions that are physiologically tolerable and preferably do not typically produce an allergic or similar untoward reaction, such as gastric upset, dizziness and the like, when administered to a human. The term “pharmaceutically acceptable” further means approved by a regulatory agency of the Federal or a State government or listed in the U.S. Pharmacopeia or other generally recognized pharmacopeia (e.g., Remington's Pharmaceutical Sciences, Mack Publishing Co. (A. R. Gennaro edit. 1985)) for use in animals, and more particularly in humans.

Administration of the protease enzymes may be carried out using any method known in the art. For example, administration may be aerosol, epicutaneous/transdermal, intra-arterial, intracapsular, intracerebroventricular, intracisternal, intracranial, intradermal, intramuscular, intranasal, intraorbital, intraperitoneal, intraspinal, intrathecal, intravenous, intraventricular, ophthalmic, oral, parenteral, subcutaneous, by suppositories, or intralymphatic administration. The term “intralymphatic” includes all lymphatic tissues, including tonsils. In some embodiments, administration is by epicutaneous/transdermal, intradermal, parenteral, subcutaneous, or intralymphatic administration.

The period of administration during the up-dosing phase and the maintenance phase may be a continuous period. Alternatively, the period of administration is a discontinuous period interrupted by one or more periods of non-administration. The (total) period of non-administration may be shorter than the (total) period of administration.

For oral administration, the protease enzymes or a therapeutically acceptable salt thereof can be formulated in unit dosage forms such as capsules or tablets. The tablets or capsules may be prepared by conventional means with pharmaceutically acceptable excipients, including binding agents, for example, pregelatinized maize starch, polyvinylpyrrolidone, or hydroxypropyl methylcellulose; fillers, for example, lactose, microcrystalline cellulose, or calcium hydrogen phosphate; lubricants, for example, magnesium stearate, talc, or silica; disintegrants, for example, potato starch or sodium starch glycolate; or wetting agents, for example, sodium lauryl sulphate. Tablets can be coated by methods well known in the art. Liquid preparations for oral administration can take the form of, for example, solutions, syrups, or suspensions, or they can be presented as a dry product for constitution with water or other suitable vehicle before use. Such liquid preparations can be prepared by conventional means with pharmaceutically acceptable additives, for example, suspending agents, for example, sorbitol syrup, cellulose derivatives, or hydrogenated edible fats; emulsifying agents, for example, lecithin or acacia; non-aqueous vehicles, for example, almond oil, oily esters, ethyl alcohol, or fractionated vegetable oils; and preservatives, for example, methyl or propyl-p-hydroxybenzoates or sorbic acid. The preparations can also contain buffer salts, flavoring, coloring, and/or sweetening agents as appropriate. If desired, preparations for oral administration can be suitably formulated to give controlled release of the active compound.

For topical administration, the protease enzymes can be formulated in a pharmaceutically acceptable vehicle containing about 0.01 percent, about 0.05 percent, about 0.1 percent, about 0.5 percent, about 1 percent, about 5 percent, or about 10 percent, or any percent between or including these values, of the active compound(s). Such formulations can be in the form of a cream, lotion, sublingual tablet, aerosols and/or emulsions and can be included in a transdermal or buccal patch of the matrix or reservoir type as are conventional in the art for this purpose.

For parenteral administration, the protease enzymes may be administered by either intravenous, subcutaneous, or intramuscular injection, in compositions with pharmaceutically acceptable vehicles or carriers. The protease enzymes can be formulated for parenteral administration by injection, for example, by bolus injection or continuous infusion. Formulations for injection can be presented in unit dosage form, for example, in ampoules or in multi-dose containers, with an added preservative. The compositions can take such forms as suspensions, solutions, or emulsions in oily or aqueous vehicles, and can contain formulatory agents, for example, suspending, stabilizing, and/or dispersing agents. Alternatively, the active ingredient can be in powder form for constitution with a suitable vehicle, for example, sterile pyrogen-free water, before use.

For administration by injection, the compound(s) may be used in a sterile aqueous vehicle which may also contain other solutes such as buffers or preservatives as well as sufficient quantities of pharmaceutically acceptable salts or of glucose to make the solution isotonic. In some embodiments, the pharmaceutical compositions may be formulated with a pharmaceutically acceptable carrier to provide sterile solutions or suspensions for injectable administration. In particular, injectables can be prepared in conventional forms, either as liquid solutions or suspensions, solid forms suitable for solution or suspensions in liquid prior to injection or as emulsions. Suitable excipients are, for example, water, saline, dextrose, mannitol, lactose, lecithin, albumin, sodium glutamate, cysteine hydrochloride, or the like. In addition, if desired, the injectable pharmaceutical compositions may contain minor amounts of nontoxic auxiliary substances, such as wetting agents, pH buffering agents, and the like. If desired, absorption enhancing preparations (e.g., liposomes) may be utilized. Suitable pharmaceutical carriers are described in “Remington's Pharmaceutical Sciences” by E. W. Martin.

For administration by inhalation, the protease enzymes may be conveniently delivered in the form of an aerosol spray presentation from pressurized packs or a nebulizer, with the use of a suitable propellant, for example, dichlorodifluoromethane, trichlorofluoromethane, dichlorotetrafluoroethane, carbon dioxide, or other suitable gas. In the case of a pressurized aerosol, the dosage unit can be determined by providing a valve to deliver a metered amount. Capsules and cartridges of, for example, gelatin for use in an inhaler or insufflator can be formulated containing a powder mix of the compound and a suitable powder base, for example, lactose or starch. For intranasal administration the protease enzymes may be used, for example, as a liquid spray, as a powder or in the form of drops.

The protease enzymes can also be formulated in rectal compositions, for example, suppositories or retention enemas, for example, containing conventional suppository bases, for example, cocoa butter or other glycerides.

Furthermore, the protease enzymes can be formulated as a depot preparation. Such long-acting formulations can be administered by implantation (for example, subcutaneously or intramuscularly) or by intramuscular injection. Thus, for example, the protease enzymes can be formulated with suitable polymeric or hydrophobic materials (for example as an emulsion in an acceptable oil) or ion exchange resins, or as sparingly soluble derivatives, for example, as a sparingly soluble salt.

The compositions can, if desired, be presented in a pack or dispenser device that can contain one or more unit dosage forms containing the active ingredient. The pack can, for example, comprise metal or plastic foil, for example, a blister pack. The pack or dispenser device can be accompanied by instructions for administration.

A “therapeutically effective amount” or “effective amount” of a composition is an amount calculated to achieve a desired effect such as to treat, combat, ameliorate, prevent or improve an unwanted condition or disease of a patient. The activity contemplated by the present methods includes both medical therapeutic and/or prophylactic treatment, as appropriate. A therapeutically effective amount of compound of this invention is typically an amount sufficient to achieve an effective systemic concentration or local concentration in the tissue when it is administered in a physiologically tolerable excipient composition.

The protease enzymes may be administered to a patient at therapeutically effective doses to prevent, treat, or control diseases and disorders mediated, in whole or in part, by abnormal protein collection. Pharmaceutical compositions comprising one or more of protease enzymes may be administered to a patient in an amount sufficient to elicit an effective protective or therapeutic response in the patient. The therapeutically effective dose will be determined by the efficacy of the particular compound employed and the condition of the subject, as well as the body weight or surface area of the area to be treated. The compounds are effective over a wide dosage range and, for example, dosages per day will normally fall within the range of from about 0.001 to about 10 mg/kg, more usually in the range of from about 0.01 mg/kg to about 1 mg/kg. However, it will be understood that the effective amount administered will be determined by the physician in the light of the relevant circumstances including the conditions to be treated, the choice of compound to be administered, and the chosen route of administration, and therefore the above dosage ranges are not intended to limit the scope of the invention in any way.

Toxicity and therapeutic efficacy of such protease enzymes can be determined by standard pharmaceutical procedures in cell cultures or experimental animals, for example, by determining the LD50 (the dose lethal to 50% of the population) and the ED50 (the dose therapeutically effective in 50% of the population). The dose ratio between toxic and therapeutic effects is the therapeutic index and can be expressed as the ratio, LD50/ED50. Protease enzymes that exhibit large therapeutic indices are preferred. While protease enzymes that exhibit toxic side effects can be used, care should be taken to design a delivery system that targets such protease enzymes to the site of affected tissue to minimize potential damage to normal cells and, thereby, reduce side effects.

The data obtained from cell culture assays and animal studies can be used to formulate a dosage range for use in humans. The dosage of such protease enzymes lies preferably within a range of circulating concentrations that include the ED50 with little or no toxicity. The dosage can vary within this range depending upon the dosage form employed and the route of administration. For any technology used in the methods of the present technology, the therapeutically effective dose can be estimated initially from cell culture assays. A dose can be formulated in animal models to achieve a circulating plasma concentration range that includes the IC50 (the concentration of the test compound that achieves a half-maximal inhibition of symptoms) as determined in cell culture. Such information can be used to more accurately determine useful doses in humans. Levels in plasma can be measured, for example, by high performance liquid chromatography (HPLC). In general, the dose equivalent of a modulator is from about 1 ng/kg to 10 mg/kg for a typical subject.

The amount and frequency of administration of the protease enzymes and/or the pharmaceutically acceptable salts thereof will be regulated according to the judgment of the attending clinician considering such factors as age, condition and size of the patient as well as severity of the symptoms being treated. An ordinarily skilled physician or veterinarian can readily determine and prescribe the effective amount of the drug required to prevent, counter or arrest the progress of the condition. In general it is contemplated that an effective amount would be from about 0.001 mg/kg to about 10 mg/kg body weight, and in particular from about 0.01 mg/kg to about 1 mg/kg body weight. It may be appropriate to administer the required dose as two, three, four or more sub-doses at appropriate intervals throughout the day. Said sub-doses may be formulated as unit dosage forms, for example, containing about 0.01 to about 500 mg, and in particular about 0.1 mg to about 200 mg of active ingredient per unit dosage form.

In one embodiment, the effective dose of active ingredient may range from about 10 to 3000, 20 to 900, 30 to 800, 40 to 700, 50 to 600, 60 to 500, 70 to 400, 80 to 300, 90 to 200, or 100 to 150 milligrams/day. In other embodiments, the dose may range from approximately 10 to 20, 21 to 40, 41 to 80, 81 to 100, 101 to 130, 131 to 150, 151 to 200, 201 to 280, 281 to 350, 351 to 500, 501 to 1000, 1001 to 2000, or 2001 to 3000 milligrams/day. In specific embodiments, the dose may be at least approximately 20, 40, 80, 130, 200, 280, 400, 500, 750, 1000, 2000, or 3000 milligrams/day. The dosage may be administered every day for 1 day, 2 days, 3 days, 4 days, 5 days, 6 days, 7 days, 8 days, 9 days, 10 days, 11 days, 12 days, 13 days, 14 days, 15 days, 21 days, 28 days, 35 days, 42 days, 49 days, 56 days, 63 days, or 70 days. After this cycle, a subsequent cycle may begin approximately 1, 2, 3, 4, 5, or 6 weeks later.

In embodiments, the pharmaceutical preparation is in a unit dosage form. In such form, the preparation is subdivided into suitably sized unit doses containing appropriate quantities of the active component, e.g., an effective amount to achieve the desired purpose. The quantity of active compound in a unit dose of preparation may be varied or adjusted. In certain embodiments, the quantities of the active ingredient is from about 0.01 mg to about 1000 mg, from about 0.01 mg to about 750 mg, from about 0.01 mg to about 500 mg, or from about 0.01 mg to about 250 mg, according to the particular application. For example, in some embodiments, hyaluronidase may be present at about 500 mg, and the second protease may be present at about 500 mg, about 400 mg, about 300 mg, about 200 mg, about 100 mg, or about 50 mg, in a unit does. In some embodiments, hyaluronidase may be present at about 400 mg, and the second protease may be present at about 500 mg, about 400 mg, about 300 mg, about 200 mg, about 100 mg, or about 50 mg, in a unit dose. In some embodiments, hyaluronidase may be present at about 300 mg, and the second protease may be present at about 500 mg, about 400 mg, about 300 mg, about 200 mg, about 100 mg, or about 50 mg, in a unit does. The second protease may be any protease enzyme described herein. The actual dosage employed may be varied depending upon the requirements of the patient and the severity of the condition being treated. Determination of the proper dosage regimen for a particular situation is within the skill of the art. For convenience, the total dosage may be divided and administered in portions during the day as required.

An proteolytic enzyme agent, e.g., an agent described herein, can be provided in a kit. The kit includes (a) one or more proteolytic enzyme agents, e.g., a composition that includes one or more proteolytic enzyme agents, and (b) informational material. The informational material can be descriptive, instructional, marketing or other material that relates to the methods described herein and/or the use of the proteolytic enzyme agent for the methods described herein. For example, the informational material relates to lymphedema or cancer.

In one embodiment, the informational material can include instructions to administer the proteolytic enzyme agent in a suitable manner to perform the methods described herein, e.g., in a suitable dose, dosage form, or mode of administration (e.g., a dose, dosage form, or mode of administration described herein). Some embodiments of doses, dosage forms, or modes of administration are topical, subcutaneous, and oral administration. In another embodiment, the informational material can include instructions to administer the proteolytic enzyme agent to a suitable subject, e.g., a human, e.g., a human having, or at risk for, lymphedema or lymphatic metastasis.

The informational material of the kits is not limited in its form. In many cases, the informational material, e.g., instructions, is provided in printed matter, e.g., a printed text, drawing, and/or photograph, e.g., a label or printed sheet. However, the informational material can also be provided in other formats, such as Braille, computer readable material, video recording, or audio recording. In another embodiment, the informational material of the kit is contact information, e.g., a physical address, email address, website, or telephone number, where a user of the kit can obtain substantive information about the proteolytic enzyme agent and/or its use in the methods described herein. Of course, the informational material can also be provided in any combination of formats.

In addition to the proteolytic enzyme agent, the composition of the kit can include other ingredients, such as a solvent or buffer, a stabilizer, a preservative, a fragrance or other cosmetic ingredient, and/or a second agent for treating a condition or disorder described herein, e.g., the proteolytic enzyme agent can be coated on a pressure bandage. Alternatively, the other ingredients can be included in the kit, but in different compositions or containers than the proteolytic enzyme agent. In such embodiments, the kit can include instructions for admixing the proteolytic enzyme agent and the other ingredients, or for using the proteolytic enzyme agent together with the other ingredients.

The proteolytic enzyme agent can be provided in any form, e.g., liquid, dried or lyophilized form. In embodiments, the proteolytic enzyme agent may be substantially pure and/or sterile. When the proteolytic enzyme agent is provided in a liquid solution, the liquid solution may be an aqueous solution. The solution may be a sterile aqueous solution. When the proteolytic enzyme agent is provided as a dried form, reconstitution generally is by the addition of a suitable solvent. The solvent, e.g., sterile water or buffer, can optionally be provided in the kit.

The kit can include one or more containers for the composition containing the proteolytic enzyme agent. In some embodiments, the kit contains separate containers, dividers or compartments for the composition and informational material. For example, the composition can be contained in a bottle, vial, or syringe, and the informational material can be contained in a plastic sleeve or packet. In other embodiments, the separate elements of the kit are contained within a single, undivided container. For example, the composition is contained in a bottle, vial or syringe that has attached thereto the informational material in the form of a label. In some embodiments, the kit includes a plurality (e.g., a pack) of individual containers, each containing one or more unit dosage forms (e.g., a dosage form described herein) of the proteolytic enzyme agent. For example, the kit includes a plurality of syringes, ampules, foil packets, or blister packs, cream packs, each containing a single unit dose of the proteolytic enzyme agent. The containers of the kits can be air tight and/or waterproof.

The kit optionally includes a device suitable for administration of the composition, e.g., a syringe, swab (e.g., a cotton swab or wooden swab), patch, or any such delivery device. In a certain embodiment, the device is a swab.

The foregoing description and examples have been set forth merely to illustrate the technology and are not intended to be limiting. Since modifications of the disclosed embodiments incorporating the spirit and substance of the technology may occur to persons skilled in the art, the technology should be construed broadly to include all variations falling within the scope of the appended claims and equivalents thereof.

What is claimed is:

1. A method of treating lymphedema in a subject in need of such treatment, comprising administering at least one proteolytic enzyme to deep tissue and applying pressure to the affected area, wherein the lymphedema is treated.

2. The method of claim 1, wherein the proteolytic enzyme is a hyaluronidase enzyme.

3. The method of claim 1, wherein the proteolytic enzyme is a hyaluronidase enzyme and a second proteolytic enzyme.

4. The method of claim 3, wherein the second proteolytic enzyme is selected from tissue plasminogen activator (t-PA), anistreplase, urokinase, streptokinase, or combinations thereof.

5. The method of claim 1, wherein the application means comprises a lotion, gel, patch, injection, or combination thereof.

6. The method of claim 1, wherein the pressure comprises a massage, a sonic massage device, a vibrational massage device, a wrap, stockings, a pneumatic sleeve, or combinations thereof.

7. The method of claim 1, wherein the lymphedema is selected from a primary edema and secondary edema.

8. The method of claim 1, wherein the lymphedema is selected from mild brawny edema, moderately brawny edema, cystic fibrosis, acute inflammation, chronic inflammation, autoimmune disorder, a chronic recurrent cyst, fibro-adenoma of the breast, scars, keloids, and combinations thereof.

9. The method of claim 1, wherein the lymphedema comprises cross-linked protein, fibrin, collagen, mucus, lymphatic fluid, blood degradation products, and combinations thereof.

10. The method of claim 1, wherein the lymphedema is located in lymphatic channels, interstitial fluids, and extracellular areas.

11. The method of claim 1, further comprising a waiting period between administering the proteolytic enzyme and applying pressure.

12. The method of claim 11, wherein the waiting period is ten minutes to twenty-four hours.

13. A kit for treating a subject having abnormal protein collection in the subject's lymphatic system, the kit comprising a first proteolytic enzyme, an application means, and a pressure means.

14. The kit of claim 13, wherein the first proteolytic enzyme comprises a hyaluronidase enzyme.

15. The kit of claim 13, further comprising a second proteolytic enzyme.

16. The kit of claim 15, wherein the second proteolytic enzyme comprises t-PA, anistreplase, urokinase, streptokinase, or combinations thereof.

17. The kit of claim 15, wherein the second proteolytic enzyme is formulated in a gel, lotion, cream, patch, or a vial.

18. The kit of claim 13, wherein the first proteolytic enzyme is formulated in a gel, lotion, cream, patch, or a vial.

19. The kit of claim 13, wherein the pressure means comprises a wrap, a sonic massage device, a vibrational massage device, stockings, a pneumatic sleeve, or combinations thereof.

20. The kit of claim 13, further comprising instructions for treating abnormal protein collection in the lymphatic system.

21. A composition for treating a subject having abnormal protein collection in the subject's lymphatic system, comprising at least one proteolytic enzyme in a pharmaceutically acceptable carrier for deep tissue delivery of the proteolytic enzyme.

22. The composition of claim 21, wherein the proteolytic enzyme comprises a hyaluronidase enzyme.

23. The composition of claim 21, wherein the composition comprises a plurality of proteolytic enzymes.

24. The composition of claim 23, wherein the plurality of proteolytic enzymes comprise at least one of t-PA, anistreplase, urokinase, streptokinase, or combinations thereof.

25. The composition of claim 21, wherein the pharmaceutically acceptable carrier is selected from a gel, lotion, cream, or combinations thereof.

26. The composition of claim 21, wherein the pharmaceutically acceptable carrier comprises an excipient, carrier diluent, or auxiliary agent.

27. The composition of claim 21, wherein deep tissue delivery is delivery to lymphatic channels, interstitial fluids of the lymphatic system, and extracellular areas of the lymphatic system.

28. The composition of claim 21, wherein the pharmaceutically acceptable carrier comprises time-release agent.
